(19) United States
(12) Patent Application Publication
(10) Pub. No.: US 2005/0182691 A1
(43) Pub. Date: Aug. 18, 2005

(54) Methods and systems for illustrating and comparing product data

(76) Inventors: Mildred Karkoff, Cleveland, OH (US); Doug Beuke, Rocky River, OH (US); Debbie Patton, Pittsburgh, PA (US)

Correspondence Address: PPG Industries, Inc.;Law-Intellectual Property, One PPG Place, Pittsburgh, PA, 15272, US

(21) Appl. No.: 10/777,798

(22) Filed: Feb. 12, 2004

(51) Int. Cl. G06F 17/60

(52) U.S. Cl. 705/27

(57) ABSTRACT

Computer based systems for illustrating product data are disclosed. The systems include an input interface wherein a user selects one or more products, at least one database that includes product data of one the products, a program in communication with the input interface and the at least one database, wherein the program retrieves selected product data for user selected products, and an output interface in communication with the program that illustrates at least some of the selected product data. In the disclosed systems, the user may adjust at least some of the product data illustrated in the output interface to generate additional product data. Also disclosed are computer-based methods for generating a report that includes product data of one or more products, computer generated reports, and methods of using a computer to compare product data.

### FIELD OF THE INVENTION

The present invention relates to computer based methods and systems for illustrating and/or comparing product information, such as, for example, coatings. The present invention is also directed to methods for generating reports comprising product information, reports comprising such product information, and documents comprising such reports.

### BACKGROUND INFORMATION

Comparing competitive products can be a tedious and time-consuming task. Such products might be available from several sources and are likely to have differences in price, features, and properties. For a customer, it might be difficult, or even impossible, to effectively compare competitive products in a reasonable period of time. The difficulty of this process, therefore, can increase the likelihood that the average purchaser, or even a sophisticated purchaser, will not purchase the most desirable product in a particular case.

As a result, various methods have been proposed for the automated comparison of products. For example, U.S. Pat. No. 4,992,940 discloses an automated system to assist a user in locating and purchasing goods or services sold by a plurality of vendors. The system includes a programmed computer that is linked to a database that contains information about different products and/or services, arranged in various categories. For each product or service, the database contains information on price, vendor, specifications, and/or availability. To compare products, a customer first selects a product type. For example, in the computer field, the customer may select from various software products or hardware products, such as printers. Next, the user inputs specifications for the selected product from a template or questionnaire provided by the system. The system then searches for products fulfilling the selected criteria and displays the results of the search. The user may then view suppliers of a particular product, view detailed specifications concerning a product, or exit.

U.S. Patent Application Publication No. 2003/0187705A1 (“the '705 application”) discloses systems and methods of comparing product information, particularly cruise package and pricing information. The '705 application discloses a method of providing cruise package and pricing information for comparison utilizing a cruise web server environment to electronically communicate via a data communications network with a plurality of remote users using web browser programs. The method comprises receiving a selection of at least two cruise packages from a remote user's web browser program, and obtaining cruise package and pricing information that corresponds to the at least two cruise packages from an electronic database of cruise data. The method also comprises preparing the cruise package and pricing information for display in an electronic web document and sending the prepared cruise package pricing information to the remote user's web browser program.

U.S. Patent Application Publication No. 2003/0125994 (“the '994 application”) discloses an interactive interface for displaying data regarding a number of different travel related products, as well as a method for displaying such data. In particular, the interactive interface disclosed in the '994 application enables customers to selectively view product displays for a number of different travel products. Each product display is constructed in a similar manner which allows customers to easily identify various product options and to compare the prices offered by various suppliers.

A competitive product comparison tool for coating products can be found at the Internet website www.matrixsystem.com/ccomparison.html. With this tool, a user can retrieve .pdf files that include cost comparisons between various Matrix coatings and those of other coatings suppliers, though the user cannot select which specific products will be compared. The .pdf files include charts and bar graphs comparing sprayable costs between coatings.

One feature that is lacking in these tools, however, is that they provide no opportunity for the user to modify any of the data or information presented by the tool to describe the products. For at least this reason, these prior art tools may not be ideal in certain circumstances. For example, there are situations when a sales or marketing person may want to present a specific customer, or groups of customers, with product information that is tailored to that customer. Such a person could benefit from a tool that retrieves selected product information from a database and illustrates such information in an interface wherein the user may modify at least some of that information to generate additional information. The user could then generate a report that, for example, is tailored to a particular customer. For example, in certain situations, a user may need to adjust the price of a product to present accurate product information in a particular case, such adjustment may, for example, reflect customer discounts and the like.

Accordingly, there is a need for new methods and systems for illustrating and/or comparing product information. There is also a need for new methods and systems for illustrating and/or comparing product information, wherein a user may modify at least some of the illustrated product information to generate additional product information. There is also a need for new methods for generating reports comprising product information, reports comprising such product information, and documents comprising such reports.

### SUMMARY OF THE INVENTION

In one respect, the present invention is directed to computer based systems for illustrating product data. These systems of the present invention comprise: (a) an input interface wherein a user selects one or more products; (b) at least one database comprising product data of the products; (c) a program in communication with the input interface and the at least one database, wherein the program retrieves selected product data for products selected by the user; and (d) an output interface in communication with the program, which illustrates at least some of the selected product data. The computer based systems of the present invention are interactive with the user such that the user may adjust at least some of the product data illustrated in the output interface to generate additional product data.

In another respect, the present invention is directed to computer-generated reports. The reports comprise selected product data of one or more products. The product data included in the reports of the present invention is retrieved from at least one database comprising product data of one or more products and at least some of the product data is adjustable in the output interface to generate additional product data.

In yet another respect, the present invention is directed to computer-based methods for generating a report comprising product data of one or more products. These methods of the present invention comprise the steps of (a) receiving a selection of one or more products from a user via an input interface; (b) retrieving product data of the one or more products from at least one database comprising product data of one or more products; (c) illustrating selected product data of the one or more products in an output interface; and (d) generating a report that illustrates the contents of the output interface. In these methods of the present invention, at least some of the illustrated product data is adjustable by the user in the output interface to thereby generate additional product data.

In still another respect, the present invention is directed to methods of using a computer to compare products. These methods of the present invention comprise the steps of (a) using a computer-based input interface to input a selection of at least two products to be compared; and (b) reviewing an output interface illustrating selected product data of the at least two products, wherein the selected product data is retrieved from at least one database comprising product data of at least two products; and wherein at least some of the illustrated product data is adjustable by the user in the output interface.

### DESCRIPTION OF THE DRAWINGS

FIG. 1 is a block diagram illustrating the general arrangement of components of a system for illustrating product data in accordance with certain non-limiting embodiments of the present invention;

FIGS. 2a-2j are examples of user screens associated with an input interface in accordance with certain non-limiting embodiments of the present invention;

FIGS. 3a-3b are examples of an output interface in accordance with certain non-limiting embodiments of the present invention;

FIG. 4 is a report in accordance with certain non-limiting embodiments of the present invention; and

FIG. 5 is a flowchart depicting a computer-based method of generating a report in accordance with certain non-limited embodiments of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. It is also to be understood that the specific devices and processes are simply exemplary embodiments of the invention. Hence, specific dimensions and other physical characteristics related to the embodiments disclosed herein are not to be considered as limiting. For example, and without limitation, it should be understood that while the following discussion is directed to computer based systems and methods of illustrating and/or comparing product information relating to coatings, the invention is not necessarily limited to such products and can be used to compare competitive product information in other fields.

In accordance with certain embodiments of the present invention, there are provided computer based methods and systems for illustrating and/or comparing product data. The computer based systems of the present invention comprise: (a) an input interface wherein a user selects one or more products; (b) at least one database comprising product data of the products; (c) a program in communication with the input interface and the at least one database, wherein the program retrieves selected product data for products selected by the user; and (d) an output interface in communication with the program, which illustrates at least some of the selected product data, wherein the user may adjust at least some of the product data illustrated in the output interface to generate additional product data.

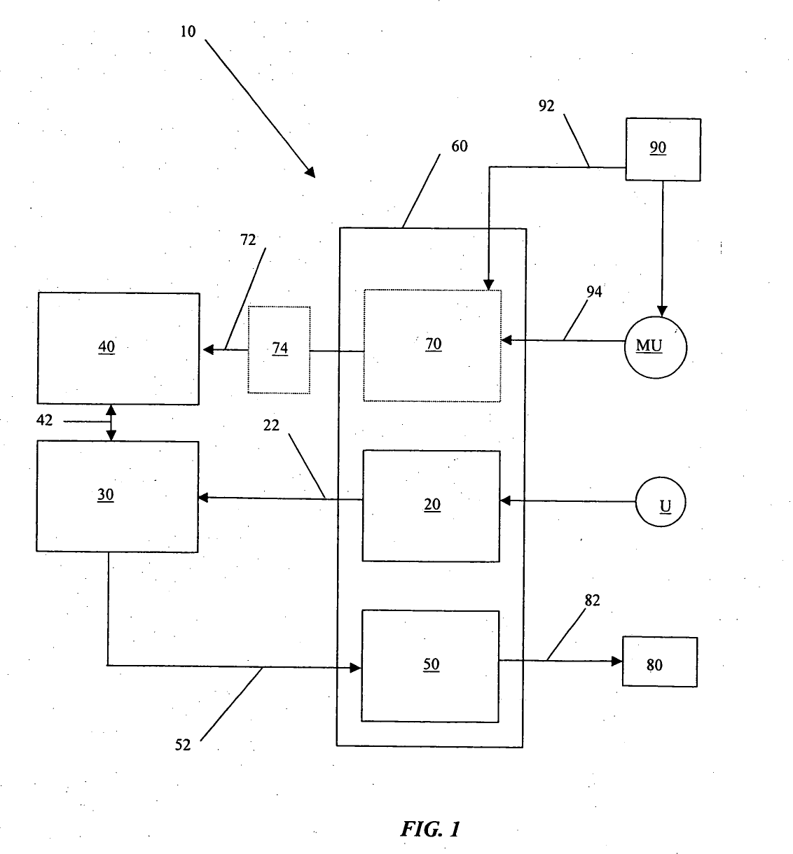

FIG. 1 is a block diagram illustrating the basic arrangement of components of a system in accordance with certain embodiments of the present invention. As is apparent, system 10 comprises input interface 20, program 30, database 40, and output interface 50, wherein program 30 is in communication with each of input interface 20, database 40 and output interface 50. In the particular non-limiting embodiment illustrated in FIG. 1, input interface 20 and output interface 50 reside on computer 60, but program 30 and database 40 reside elsewhere, such as one or more other computers (not shown). It will be appreciated, however, that the particular location of input interface 20, program 30, database 40, and output interface 50 is not critical. For example, in certain embodiments of the present invention, each of input interface 20, program 30, database 40, and output interface 50 may reside on computer 60. In certain embodiments, computer 60 has an operating system that is Microsoft Windows 95, Windows 98, Windows 2000, or Windows NT.

In the embodiment illustrated in FIG. 1, program 30 is in communication with input interface 20, database 40, and output interface 50 via communication media 22, 42, and 52 respectively. While the particulars of communication media 22, 42 and 52 are not limiting in the present invention, in certain embodiments of the invention these communication media may include, for example, one or more types of computer networks, such as, for example, local area networks (“LANs”), wide area networks (“WANs”), public Internets, private Internets, a private computer network, a secure Internet, a private network, a public network, a value-added network, interactive television networks, wireless data transmission networks, two-way cable networks, interactive kiosk networks, digital subscriber lines, cable modem lines, and the like.

As will be understood by those skilled in the art, the Internet is a global network of interconnected computers capable of sending and receiving information between and among one another. The structure of the Internet, which is well known to those of skill in the art, includes a network backbone comprising communications channels such as copper wire, optical fiber, or satellite based interconnections between numerous computers, hubs, and routers which control, direct, and maintain information passed between computers. Additional networks branch from the above-mentioned backbone, and these branches, in turn, have sub-networks branching from them, and so on. Typically, information is passed through the network in the form of packets, which are discrete pieces of information desirably sent through the network. These packets of information are encoded in a form interpretable by the network infrastructure and may support features such as data compression, encryption, and error correction to optimize the speed and efficiency by which the information is transferred. For a more detailed description of the structure and operation of the Internet, see “The Internet Complete Reference,” by Harley Hahn and Rick Stout, published by McGraw-Hill, 1994.

Referring once again to FIG. 1, it is seen that, in certain embodiments of the systems of the present invention, there is included a maintenance interface 70 that is in communication with a maintenance program 74, which is in communication with the database 40 via communication medium 72. Communication medium 72 may comprise, without limitation, any of the communication media referred to earlier. In certain embodiments, product data 90 is delivered to maintenance interface 70 via communication media 92 or 94. Communication media 92 may comprise, without limitation, any of the communication media referred to earlier and represents a scenario where product data 90 is downloaded directly to computer 60 from another computer (not shown). Communication media 94, on the other hand, represents the scenario wherein the product data 90 is delivered to maintenance interface 70 via a maintenance user, depicted as “MU” in FIG. 1. In this case, the maintenance user delivers product data 90 to maintenance interface 70 through any common input device known to those skilled in the art, such as a keyboard, a track ball and/or mouse and the like.

In the embodiments of the systems of the present invention illustrated in FIG. 1, there is also included an output device 80 that is in communication with the output interface 50 via communication medium 82. In this embodiment, output device 80 does not reside on computer 60 and may comprise, for example, any of the conventional output devices known to those skilled in the art, such as printers, fax machines, diskettes, compact discs and the like. Communication medium 82 is not particularly limited and may comprise, for example, any of the conventional communication media known to those skilled in the art, such those mentioned earlier as well as cables and the like.

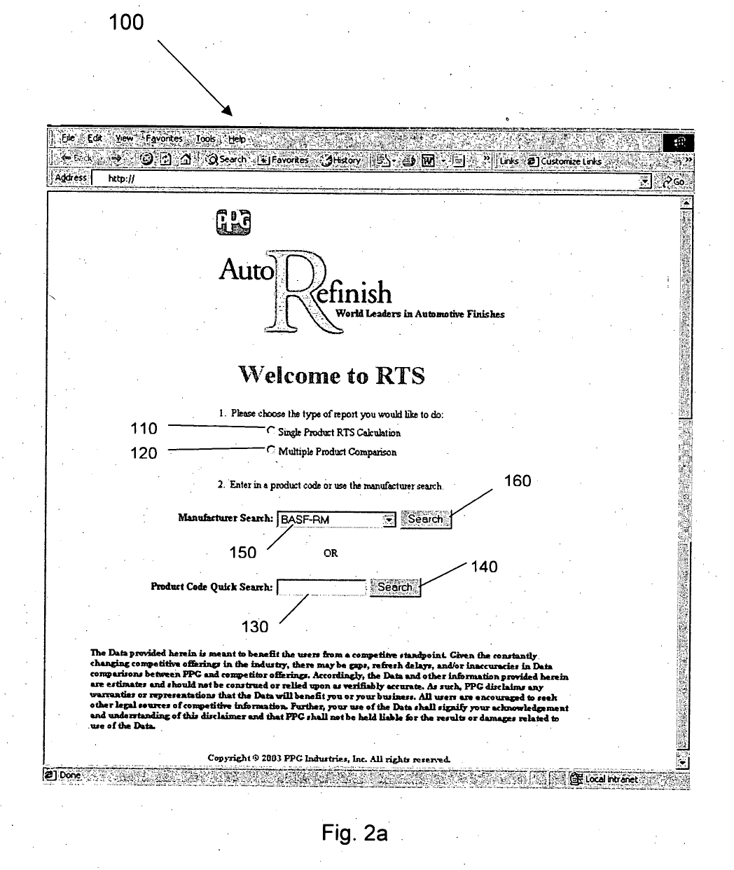

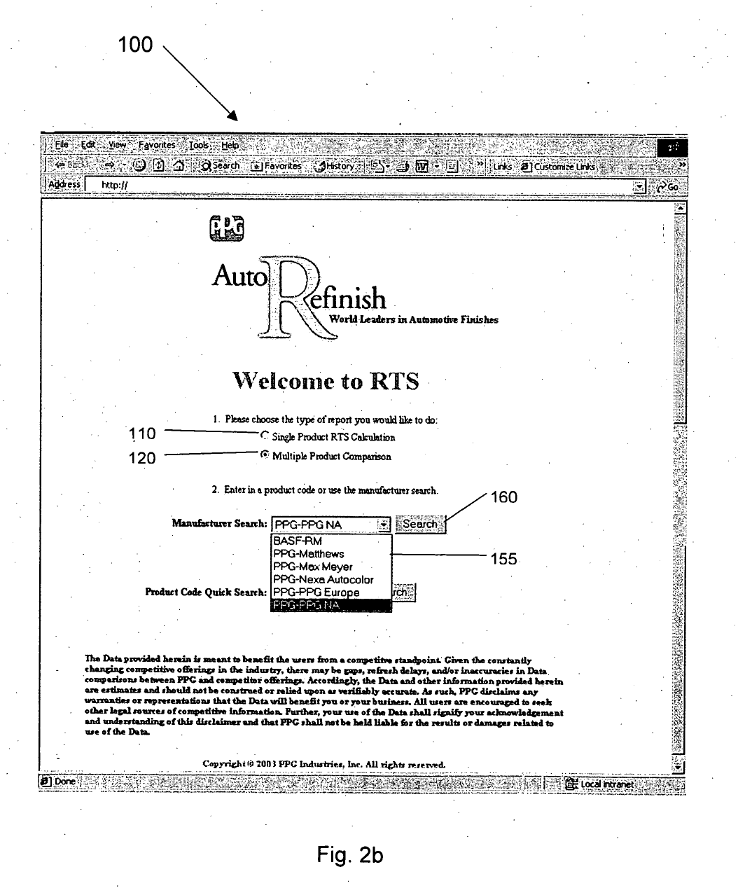

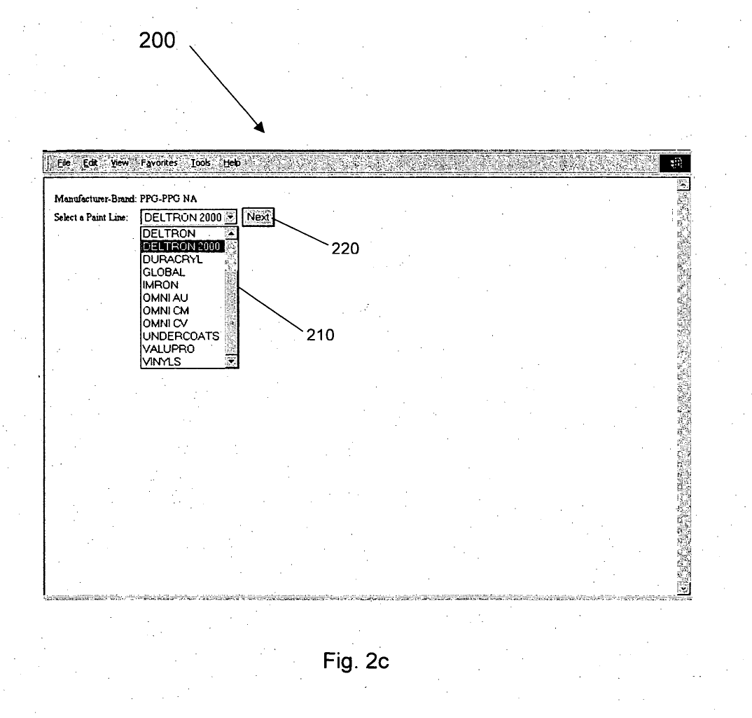

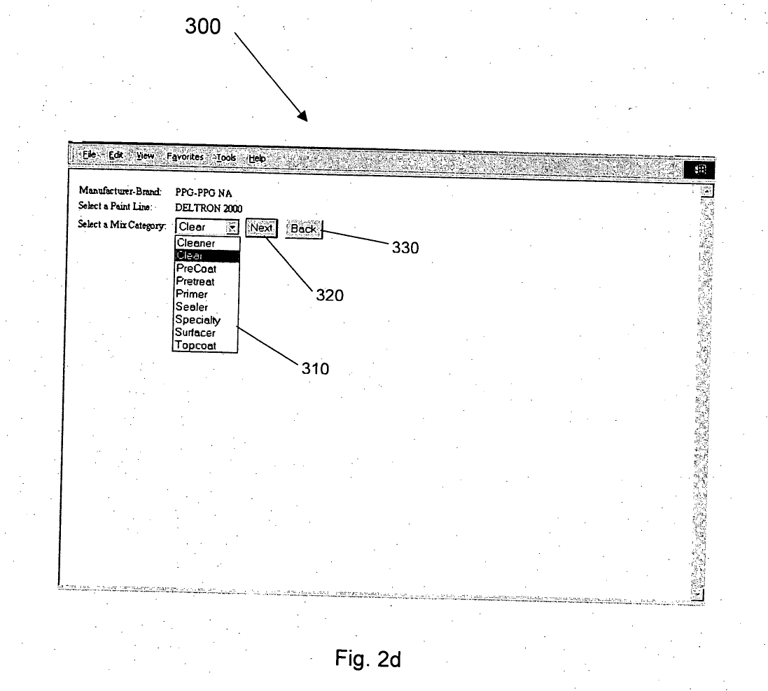

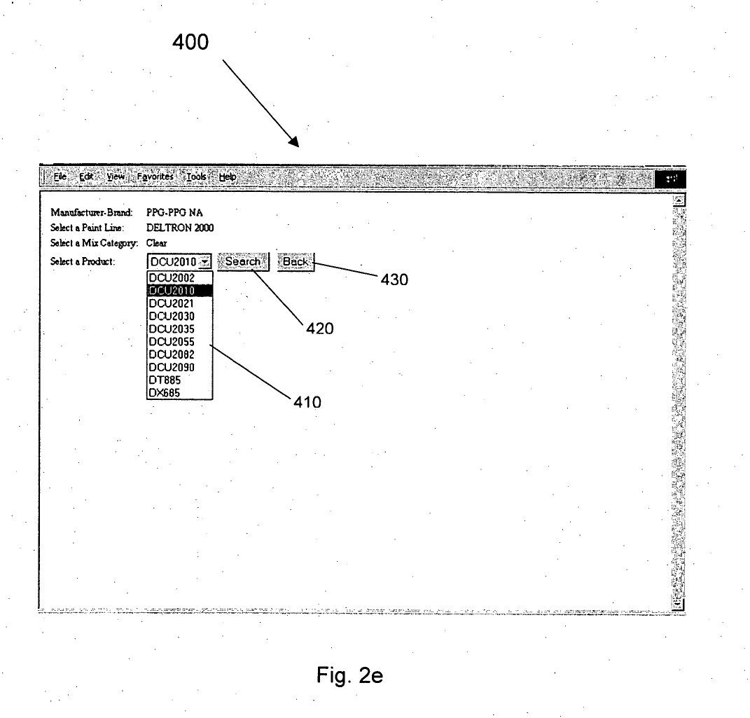

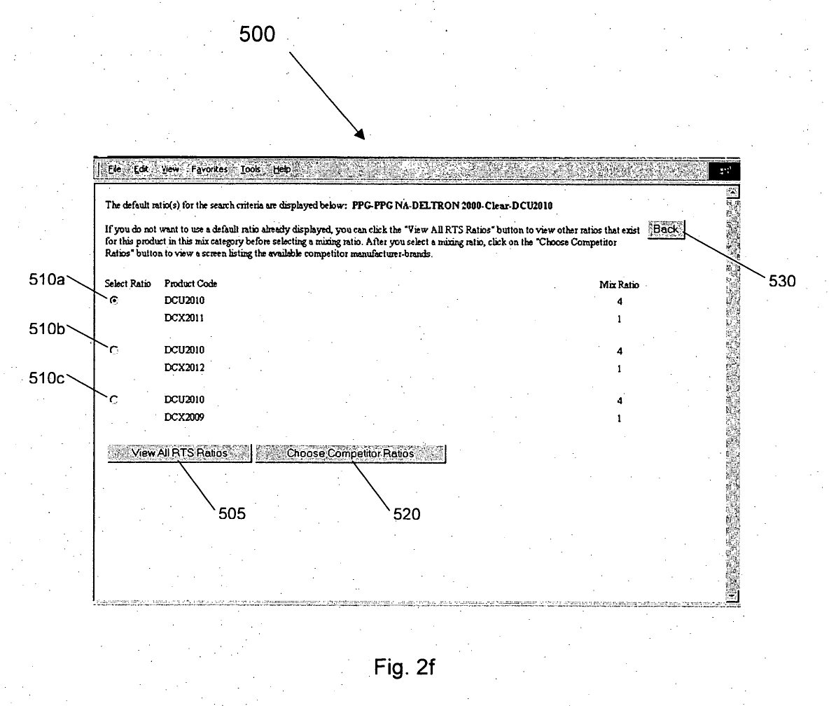

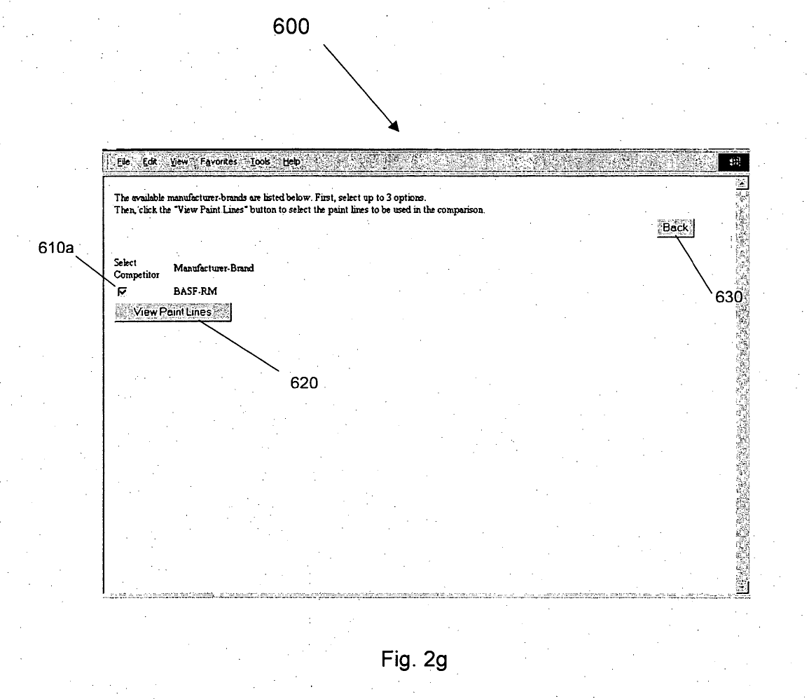

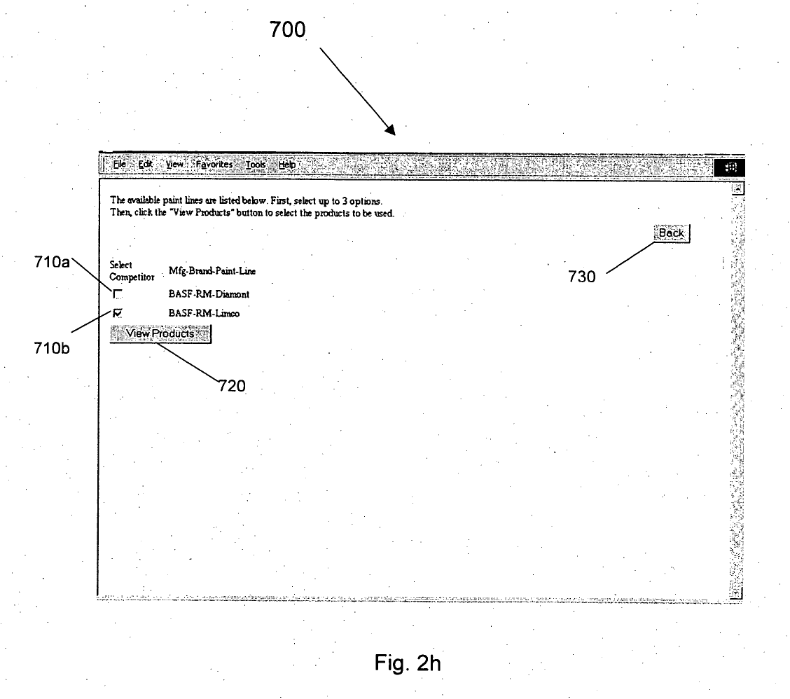

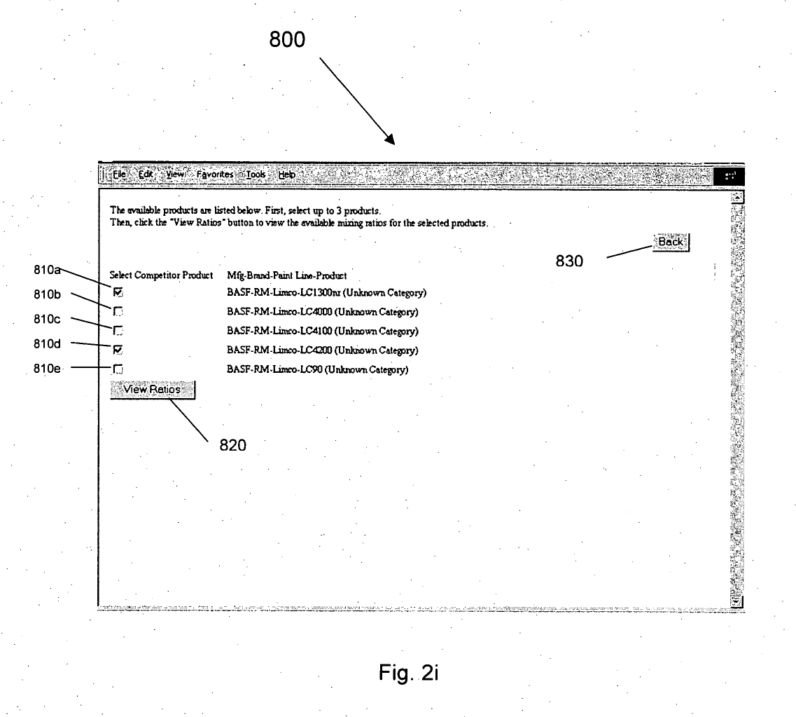

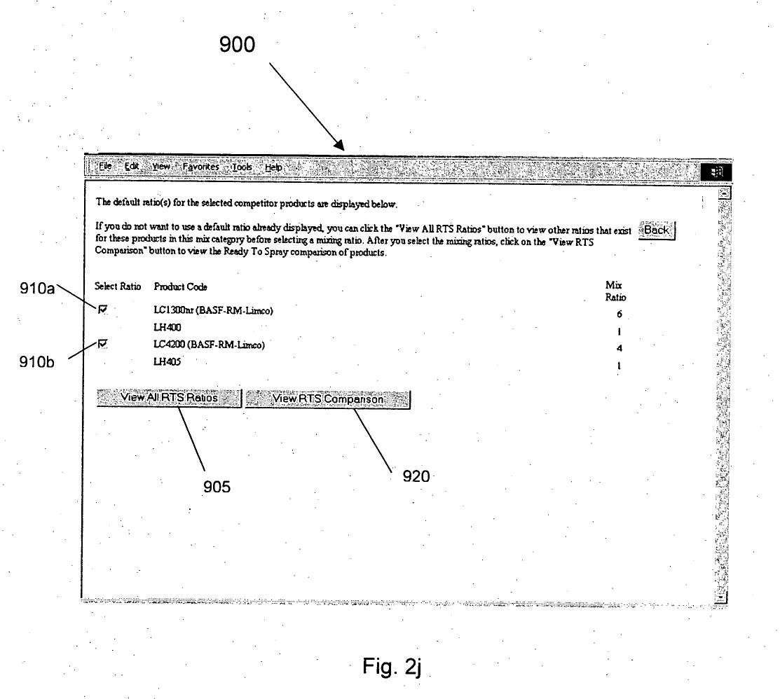

As mentioned above, the systems of the present invention comprise an input interface 20 wherein a user, identified as “U” in FIG. 1, selects one or more products. As used herein, “input interface” refers to a tool for inputting information. In certain embodiments, the user the selects two products to be compared, although more or less than two products may be selected, as will be illustrated herein. In certain embodiments of the present invention, the input interface 20 comprises a series of input screens, such as those illustrated in FIGS. 2a-2j. In a particular example of the present invention to now be described, the products are coatings and the product comparison is with respect to price, namely the “ready-to-spray” (“RTS”) price of coatings. It should be understood, however, that the present invention can be used to compare products or services in other fields and is not necessarily limited to comparing coatings. Also, it should be understood that, with respect to coatings, the present invention can be used to perform other comparisons and is not necessarily limited to comparing RTS price.

As will be understood by those skilled in the art, a particular coating may comprise one or more components, such as, for example, resins, hardeners, solvents (thinners), pigments, adhesion promoters, flattening additives, among others. As used herein, the term “component data” refers to any factual information relating to a component of a coating. Component data may include, for example, at least one of a code, a description (which may, for example, designate a coating quality grade), a price, and a package size. In some cases, a component may have different prices depending on, for example, the size of the package and/or the particular type of customer to whom the product is directed. For example, coating components may be sold in quart, gallon, 5 gallon, and/or 55 gallon containers, among others. Also, in the automotive refinish industry, for example, a particular product may be sold at a different price to jobbers and body shops.

The RTS price of a coating product accounts for the price of each coating component and their relative amounts in the coating product. For example, if a coating product comprises 4 parts by volume of component A, 1 part by volume of component B, and 2 parts by volume of component C and the cost of component A is $20/quart, the cost of component B is $10/quart, and the cost of component C is $30/quart, the RTS price per quart of coating is calculated as follows:
RTS price=(4/7)(20)+(1/7)(10)+(2/7)(30)=$21.43/quart

As mentioned above, in certain embodiments of the systems of the present invention, the input interface may comprise one or more input screens. Now referring to FIGS. 2a-2j, there are seen input screens in accordance with certain embodiments of the input interface 20 of the present invention. Referring first to FIG. 2a, there is shown a report selection screen 100 whereby the user, in accordance with certain embodiments of the present invention, may select the type of report she wishes to receive. At a first knob 110, the user may select a report that does not compare competitive coatings, but, rather, such a report provides a RTS price for a particular coating selected by the user. Thus, by selecting knob 110, the user will select only a single product. At a second knob 120, however, the user will select at least two products to be compared.

As is also apparent from FIG. 2a, the user also may select from alternative means of identifying a first product. In particular, the user may enter a known product code at field 130 and then press the “search” button 140. Alternatively, the user may identify a first product by means of a search tool that is accessed by selecting field 150 and then pressing the “search” button 160. A search tool that makes up part of the input interface 20 in accordance with certain non-limiting embodiments of the present invention will now be described by reference to the input screens of FIGS. 2b-2f.

Referring now to FIG. 2b, which depicts a report selection screen 100 in accordance with certain embodiments of the present invention, it is seen that the user has selected field 120. Therefore, in this example, the user will select at least two products to be compared. As is also apparent, the user has selected field 150 to access the search tool, which, in this example, provides that the user selects a coating supplier and coating brand for the first product to be compared by selecting from a list of suppliers and brands 155, which list is depicted as a “drop-down” window in FIG. 2b. The means of generating list 155 is not critical in the present invention and may, for example, result from a query of database 40 for the suppliers and brands contained therein or list 155 could be contained within the report selection screen 100 itself.

As used herein, the term “product brand” refers to a group of products sold by a supplier under a particular identity. As will be appreciated by those skilled in the art, supplier and brand list 155 identifies some coating product suppliers and brands, though the list 155 is not necessarily exhaustive. In the example illustrated by FIG. 2b, the user has selected PPG Industries, Inc.—North America (“PPG-PPGNA”), as the coating supplier and brand for the first product to be compared. Once the first product supplier and brand is selected, the user presses the “search” button 160 to proceed to, for example, a first product paint line selection screen 200, an example of which is shown in FIG. 2c.

Referring now to FIG. 2c, which depicts a first product paint line selection screen 200 in accordance with certain embodiments of the present invention, it is seen that, via this screen, the user, when using the search tool of certain embodiments of the systems of the present invention, selects a paint line for the first product. As used herein, the term “paint line” refers to a series of compatible coatings within a given brand that are designed to function together. The first product paint line, may, for example, be selected from a list of product paint lines 210 of the first supplier selected by the user from the supplier list 160 of report selection screen 100. In the example shown in FIG. 2c, the list of product paint lines 210 is depicted as a “drop-down” window. The means of generating list 210 is not critical in the present invention and may, for example, result from a query of database 40 for the paint lines contained therein for the selected paint supplier and brand, or list 210 could be contained within the first product paint line selection screen 200 itself.

As will be appreciated by those skilled in the art, the product paint line list 210 identifies some product paint lines of the first supplier, though the list 210 is not necessarily exhaustive. In the example illustrated by FIG. 2c, the user has selected the DELTRON 2000 product paint line of PPG-PPGNA. Once the first product paint line is selected, the user presses the “next” button 220 to proceed to, for example, a first product mix category screen 300, an example of which is shown in FIG. 2d.

As will be appreciated by those skilled in the art, a particular coating paint line typically comprises various coating systems that are made up of different categories of coatings, such as, for example, cleaners, clear coats, precoats, pretreatments, primers, sealers, specialty coatings, surfacers, topcoats, among others. When using the search tool of certain embodiments of the present invention, a first product mix category screen 300, such as is depicted in FIG. 2d, may provide for the user to select the coating category of the first product. The first product category may, for example, be selected from a list of categories 310, which is depicted as a “drop-down” window in FIG. 2d. As will be appreciated by those skilled in the art, the category list 310 is not necessarily exhaustive. The means of generating category list 310 is not critical in the present invention and may, for example, result from a query of database 40 for the categories contained therein for the selected paint supplier, brand and paint line, or list 310 could be contained within the first product paint line selection screen 300 itself.

In the example illustrated by FIG. 2d, the user has pressed the “Clear” category (referring to clear coats). Once the category is selected, the user presses the “next” button 320 to proceed. Should, however, the user decide to change the selection of the first product paint line, the user may press the “back” button 330, which returns the user to the first product paint line selection screen 200.

If the user presses the “next” button 320 on the first product mix category screen 300, she will, in certain embodiments of the present invention, proceed to a first product selection screen 400, an example of which is shown by FIG. 2e. As is apparent, via the first product selection screen 400 the user, when using a search tool of certain embodiments of the present invention, may select the first product. The product may, for example, be selected from a list of products 410, which is depicted as a “drop-down” window in FIG. 2e. The means of generating product list 410 is not critical in the present invention and may, for example, result from a query of database 40 for the products contained therein for the selected paint supplier, brand, paint line, and mix category, or list 410 could be contained within the first product selection screen 400 itself.

In this example, the product list includes resins that are available in “Clears” for the DELTRON 2000 brand of coating products based on the user's prior selections. As illustrated by FIG. 2e, the user has selected the first product to be compared by selecting DCU2010 Clear. Once the product is selected, the user presses the “search” button 420 to proceed. Should, however, the user decide to change the selection of the first product, the user may press the “back” button 430, which returns the user to the first product mix category screen 300.

In certain embodiments of the present invention, the user, by pressing the “search” button on the first product selection screen 400, causes the program 30 of the systems of the present invention, which is in communication with the input interface 20, to communicate with database 40 and retrieve, from the database 40, selected product data for the first product selected by the user. As used herein, the term “product data” refers to any factual information relating to a product, such as, in the case of coatings, component data (discussed earlier), one or more component-mixing ratios, and one or more RTS prices.

As used herein, the term “program” refers to logic that queries the database for selected product data for products selected by the user and retrieves that data. The logic may embodied in hardware components, firmware, or a collection of software instructions, written in one or more programming languages, such as, for example, C++, VISUAL BASIC, JAVA, C, FORTRAN, VBScript and JAVA Script, among others. Hardware components may be comprised of connected logic units, such as gates and flip-flops, and/or may be comprised of programmable units, such as programmable gate arrays or processors. The procedure for creating such logic would be readily apparent to one of ordinary skill in the art and thus will not be described here.

As mentioned above, input interface 20 may, in certain embodiments of the invention, communicate with program 30 via a communication medium comprising the Internet. One segment of the Internet is the World Wide Web, which comprises many thousands of computers, which utilize the Internet infrastructure to serve and distribute information. In certain embodiments of the present invention, program 30 may reside on a device known as a server.

As used herein, a “server” is a device that can be equipped to offer World Wide Web access. As will be appreciated by those skilled in the art, a server accommodates requests for information and facilitates the retrieval of requested files or applications from another computer. Typically, a server is capable of two-way communication with other computers and can desirably send information to other computers which request the information or content stored on the server system. The information stored on the server system is typically interpreted using a software package known as a browser, which is capable of displaying graphical, textual, audio and/or visual information.

Some server systems, which provide information on the World Wide Web, are referred to as “websites” and interact with other computers on the World Wide Web. Generally, each website has an associated electronic page or series of electronic pages which the server sends to those computers requesting the information. The requested information generally takes the form of an electronic page (or web page) encoded in one or more specific languages that is interpreted by the requesting computer and the browser, which it runs. Several such languages commonly used by web servers include, but are not limited to, Hypertext Markup Language (“HTML”), JAVA, JAVA Script, Extensible Markup Language (“XML”), Active Server Pages (“ASP”), and CGI scripting. The web page provides the requesting computer with a document that organizes the presentation of the information into a display using text, graphical images, audio, and/or video. Furthermore, the computer, on which the online document is viewed, may communicate with the website by sending and receiving information through interface objects such as, for example, fields, buttons, pull down menus, and key entered commands. For a more detailed description on the World Wide Web, see “How to Set Up and Maintain a World Wide Web Site” by Lincoln D. Stein, published by Addison-Wesley Publishing Company, 1995.

As mentioned above, the systems of the present invention comprise at least one database 40 that comprises product data for the products, wherein the database 40 is in communication with the program 30, such as is depicted in FIG. 1. Moreover, as illustrated herein, the database may comprise product data for one or more products of different product suppliers. The information stored within the database is the fundamental product data for all the products of all the suppliers that may be compared in the systems and methods of the present invention. The data may come from any source, but often comes from publicly available sources, such as product data sheets, product catalogs, material safety data sheets, and the like. The type of database in which the product data is stored is not critical. Examples of the types of databases that may be used in the present invention include, without limitation, Microsoft Access databases, Oracle databases, SQL Server databases, and Microsoft Excel spreadsheets, among others. The procedure for creating a database that includes product data as described herein would be readily apparent to one of ordinary skill in the art and thus will not be described here.

In certain embodiments of the systems of the present invention, the product data in database 40 can be modified. For example, the database can be updated, possibly at regular intervals, to include additional products, remove products, or update information about products existing in the database. The means used to modify such data, however, is not critical. Referring once again to FIG. 1, it is seen that, in certain embodiments of the present invention, a maintenance user “MU” may modify product data in the database 40 via maintenance interface 70, which is in communication with maintenance program 74, which is in communication with database 40. In this example, the maintenance interface may comprise one or more maintenance screens wherein a maintenance user selects the product data to be added, removed, or modified. The maintenance interface 70 communicates with maintenance program 74 which communicates with database 40 to thereby modify the selected product data in database 40. In another embodiment, also shown in FIG. 1, product data in the database 40 may be modified without interaction of a maintenance user. As shown in FIG. 1, it is possible that product data could be added, removed, or modified in database 40, via a direct download over communication media 92 from, for example, another computer.

Referring now to FIG. 2f, there is seen a first product mixing ratio screen 500 to which the user is sent, in certain embodiments of the present invention, after pressing the “search” button 420 on first product selection screen 400. The first product mixing ratio screen 500 displays the results of the communication between the program 30 and database 40, wherein the program has retrieved, from the database 40, product data of the first product to be compared. In this example, the program 30 has retrieved component-mixing ratios located in database 40 for DCU2010 Clear for the PPG-PPGNA-DELTRON 2000 paint line.

As is apparent, the database 40 may include several component-mixing ratios for a certain product. In the first product mixing ratio screen 500 illustrated in FIG. 2f, there is provided a list of component-mixing ratios for the selected first product. Each listed component-mixing ratio identifies the component code for each component of the coating and the relative amounts of each component to be used. For example, the first component-mixing ratio listed comprises 4 parts of DCU2010 (a clear base resin) and 1 part DCX2011 (catalyst/hardener). Also, in the embodiment shown in FIG. 2f, the first mixing ratio screen initially illustrates what are referred to as “default ratios” which refers to the most commonly used ratios for the selected product. Should the user decide that she does not wish to use a “default ratio,” she may press the “View All RTS Ratios” button 505 to view other ratios retrieved from the database 40 for the selected product.

In certain embodiments of the present invention, the user, at the first product mixing ratio screen 500, selects the component-mixing ratio for the first product that the user wishes to have illustrated by the output interface 50. This is accomplished by selecting one of the ratio knobs 510a, 510b, 510c, etc. In the example illustrated in FIG. 2f, the user has selected ratio knob 510a. Once this selection is made, the user presses the “Choose Competitive Ratios” button 520 to proceed. Should, however, the user decide to change the selection of the first product, the user may press the “back” button 530, which returns the user to the first product selection screen 400.

Referring now to FIG. 2g, there is seen a competitive product brand selection screen 600, wherein the user may, in certain embodiments of the present invention, select one or more brands from which the user may select one or more products to be compared with the first product. The list of competitive product brands may, for example, be generated by querying the database 40 for the available competitive product brands.

It should be noted that, in the case where a user has selected to generate a report that does not compare competitive coatings, but, rather, has selected to generate a report providing product data for a single product, such as the RTS price of a particular coating, that the user would not select any product to be compared with the first product. In such a case, the user would not encounter competitive brand selection screen 600. This would be the case if, for example, the user selected field 110 in FIG. 2a.

In the particular embodiment illustrated in FIG. 2g, the user may select up to three competitive product brands. To select one or more competitive product brands, the user selects one or more competitor knobs 610a, and then presses the “View Paint Lines” button 620 to proceed. In the example illustrated in FIG. 2g, the user has selected the competitive brand identified as BASF-RM, which, in this particular example, is the only competitive product brand listed. Otherwise, the user may press the “back” button 630 to return to the first product mixing ratio screen 500.

If the user presses the “View Paints Lines” button 620 on the competitive brand selection screen 600, she will proceed, in certain embodiments of the present invention, to a competitive paint line selection screen 700, an example of which is shown by FIG. 2h. As is apparent, the competitive paint line selection screen 700 lists one or more paint lines available for the competitive brand selected by the user at the competitive brand selection screen 600. The list of competitive paint lines may, for example, be generated by querying the database 40 for the available competitive paint lines for the selected competitive product brands.

At the competitive paint line selection screen 700, the user selects one or more competitive paint lines, from which the user will be able to select one or more products to compare to the first product. In the particular embodiment illustrated in FIG. 2h, the user may select up to three competitive paint lines. To select one or more competitive paint lines, the user selects one or more competitor paint line knobs 710a, 710b, etc. and then presses the “View Products” button 720 to proceed. In the example illustrated in FIG. 2h, the user has selected one competitive paint line, which is identified as BASF-RM-Limco. Otherwise, the user may press the “back” button to return to the competitive paint line selection screen 600.

If the user presses the “View Products” button 720 on the competitive paint line selection screen 700, she will proceed, in certain embodiments of the present invention, to a competitive product selection screen 800, an example of which is shown by FIG. 2i. As is apparent, the competitive product selection screen 800 lists products of the one or more paint lines selected by the user at the competitive paint line selection screen 700. The list of competitive products may, for example, be generated by querying the database 40 for the available competitive products for the selected competitive product brands and paint lines.

At the competitive product selection screen 800, the user selects one or more competitive products that the user wishes to compare to the first product. In the particular embodiment illustrated in FIG. 2i, the user may select up to three competitive products. To select one or more competitive products, the user selects one or more of the competitor product knobs 810a, 810b, 810c, 810d, 810e, etc. In the example illustrated in FIG. 2i, the user has selected two competitive products, which are identified as BASF-RM-Limco-LC1300nr and BASF-RM-Limco-LC4200. Once the competitive products are selected, the user presses the “View Ratios” button 820 to proceed. Otherwise, the user may press the “back” button 830 to return to the competitive paint line selection screen 700.

In certain embodiments of the present invention, the user, by pressing the “View Ratios” button 820 on the competitive product selection screen 800, causes the program 30 to communicate with database 40 and retrieve selected product data for the competitive products selected by the user. In certain embodiments of the present invention, a competitive product mixing ratio screen 900, such as is illustrated by FIG. 2j, illustrates the results of that communication. In this example, the program 30 has retrieved component-mixing ratios located in database 40 for the BASF-RM-Limco-LC1300nr and LC4200 products.

It should be understood that the database 40 may include several component-mixing ratios for a selected competitive product. In the competitive product mixing ratio screen 900 illustrated in FIG. 2j, there is provided a list of component-mixing ratios for each of the selected competitive products. Each listed component-mixing ratio identifies the component code for each component of the coating and the relative amounts of each component to be used. For example, the first mixing ratio listed comprises 6 parts of LC1300nr and 1 part LH400. Also, in the embodiment shown in FIG. 2j, the competitive mixing ratio screen initially lists what are referred to as “default ratios” which refers to the most commonly used ratios for the selected product. Should the user decide that she does not wish to use a “default ratio,” she may press the “View All RTS Ratios” button 905 to view other ratios retrieved from the database 40 for the selected competitive products.

At the competitive product mixing ratio screen 900, the user, in certain embodiments of the present invention, selects which of the component-mixing ratios of the selected competitive products the user wishes to have illustrated by the output interface 50. This is accomplished by selecting one or more of the ratio knobs 910a, 910b, etc. In the example illustrated in FIG. 2j, the user has selected ratio knobs 910a and 910b. Once this selection is made, the user presses the “View RTS Comparison” button 920 to proceed. Otherwise, the user may press the “back” button 930 to return to the competitive product selection screen 800.

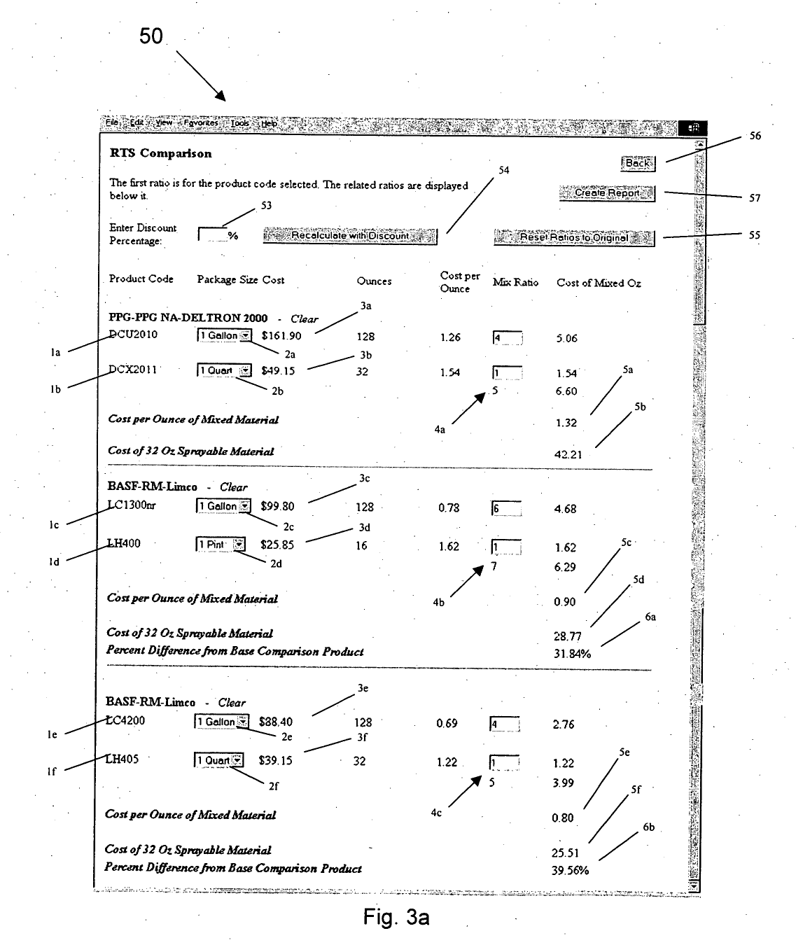

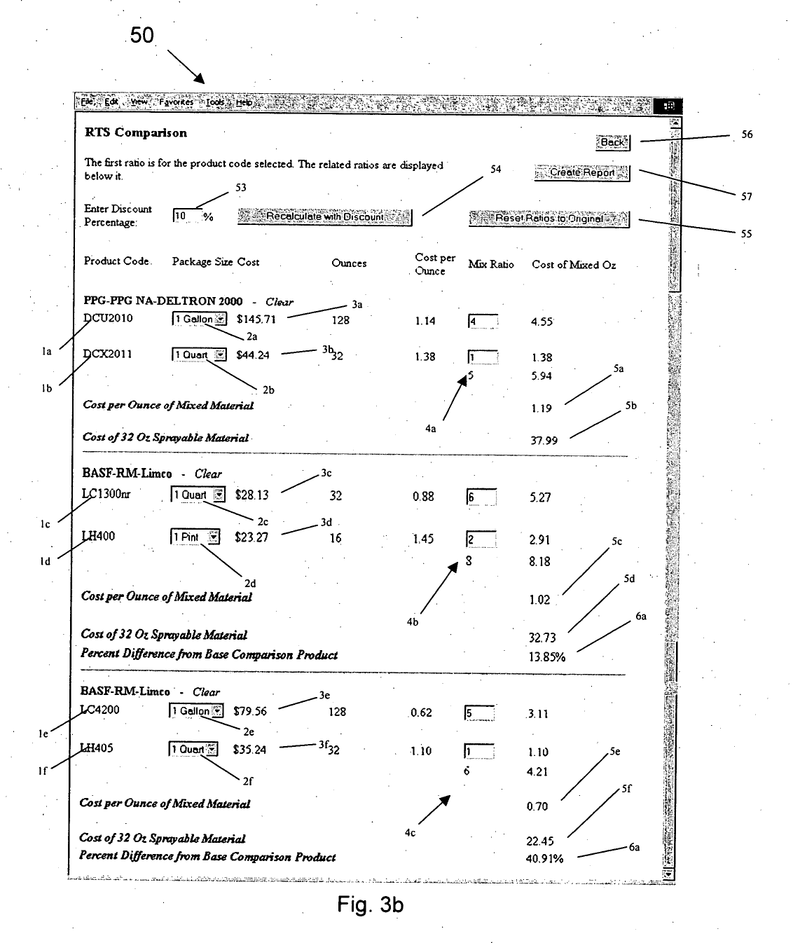

As mentioned earlier, the systems of the present invention comprise an output interface 50 in communication with the program. As used herein, “output interface” refers to a tool for outputting information. The output interface illustrates at least some of the selected product data and is interactive with the user such that the user may adjust at least some of the product data illustrated therein to generate additional product data. Now referring to FIG. 3a, there is seen an example of such an interface in accordance with certain embodiments of the present invention. In this example, the user has proceeded to the output interface 50 after pressing the “View RTS Comparison” button 920 on the competitive product mixing ratio screen 900.

In the embodiment illustrated in FIG. 3a, the output interface illustrates product data for the first selected product, in this example PPG-PPGNA-DELTRON 2000-DCU2010. First, there is displayed component data retrieved from the database 40, such as the component codes 1a and 1b, component package sizes 2a and 2b, and component prices 3a and 3b. There is also displayed one of the component-mixing ratios 4a that were retrieved from the database 40, namely the component-mixing ratio that was selected by the user at the first product mixing ratio screen. In the embodiment illustrated in FIG. 3a, the output interface 50 also illustrates several first product RTS prices 5a and 5b.

The output interface 50 depicted in FIG. 3a also displays selected product data for the selected competitive products, namely BASF-RM-Limco LC1300nr and LC4200 in this example. First, there is displayed component data retrieved from the database 40, such as the component codes 1c, 1d, 1e, and 1f, component package sizes 2c, 2d, 2e, and 2f, and component prices 3c, 3d, 3e, and 3f. There is also displayed the competitive product component-mixing ratios 4b and 4c that were retrieved from the database 40, namely the competitive product component-mixing ratios that were selected by the user at the competitive product mixing ratio screen. In the embodiment illustrated in FIG. 3a, the output interface 50 also illustrates several competitive product RTS prices 5c, 5d, 5e, and 5f. Also illustrated are the percent difference in RTS price between each selected competitive product and the first product, shown at 6aand 6b.

As mentioned above, however, the user may adjust at least some of the product data illustrated in output interface 50 to generate additional product data. In FIG. 3a, for example, the user may generate additional RTS prices by adjusting the component package sizes 2a, 2b, 2c, 2d, 2e and/or 2f, the component-mixing ratios 4a, 4b, and/or 4c, or by entering a discount percentage.

Now referring to FIG. 3b, there is seen an example of an output interface 50 wherein the user has adjusted some of the product data. Here, the user has adjusted component package size 2c and the component-mixing ratios 4b and 4c, which has caused RTS prices 5c, 5d, 5e and 5f to be adjusted. In addition, the user has adjusted RTS prices 5a and 5b by entering a discount value at field 53 and then pressing the “Recalculate with Discount” button 54. Should the user decide to revert to the original component-mixing ratio that was illustrated in FIG. 3a, she may press the “Reset Ratios to Original” button 55. Alternatively, the user may press the “back” button 56 to return to the competitive product mixing ratio screen 900.

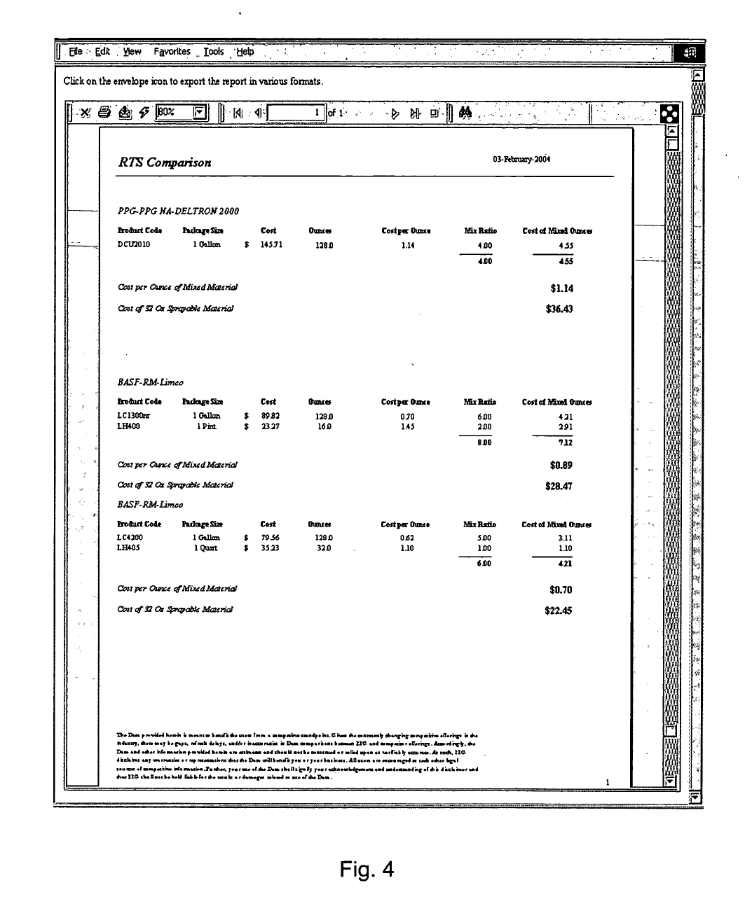

As is also apparent from FIGS. 3a and 3b, in certain embodiments of the system of the present invention, a report may be generated that illustrates the contents of the output interface 50. To generate such a report, the user may press the “Create Report” button 57 at the output interface 50 illustrated in FIGS. 3a and 3b. Referring now to FIG. 4, there is seen an example of such a report in accordance with certain embodiments of the present invention. The report may be placed on a document generated by communicating the contents of the report to an output device, such as a printer, fax machine, or the like. Thus, a document may be produced containing the report.

Based on the foregoing description, it should be apparent that the present invention is also directed to reports generated from a computer. The reports of the present invention comprise selected product data of one or more products and illustrate the contents of an output interface wherein at least some of the product data in the output interface is adjustable to generate additional product data. In the reports of the present invention, the selected product data is retrieved from at least one database comprising product data of one or more products. A document may be produced from the reports of the present invention.

The present invention is also directed to computer-based methods for generating reports comprising product data of one or more products. As should be apparent from the description herein, these methods of the present invention comprise the steps of (a) receiving a selection of one or more products from a user via an input interface, (b) retrieving product data of the one or more products from at least one database comprising product data of one or more products, (c) illustrating selected product data of the one or more products in an output interface, wherein at least some of the illustrating product data is adjustable by the user in the output interface to generate additional product data, and (d) generating a report that illustrates the contents of the output interface. Such methods may also, in certain cases, comprise the step of delivering the contents of the report to an output device.

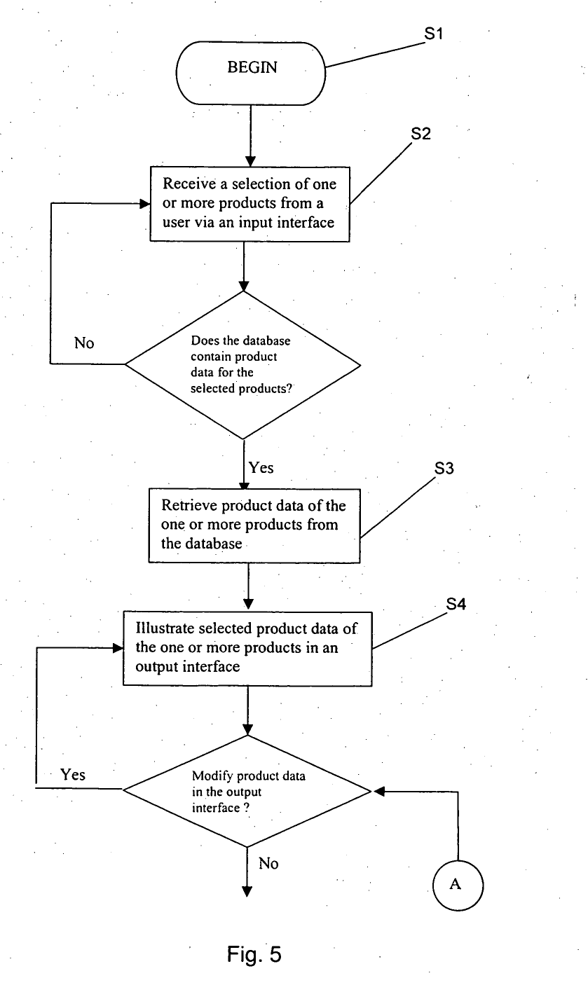

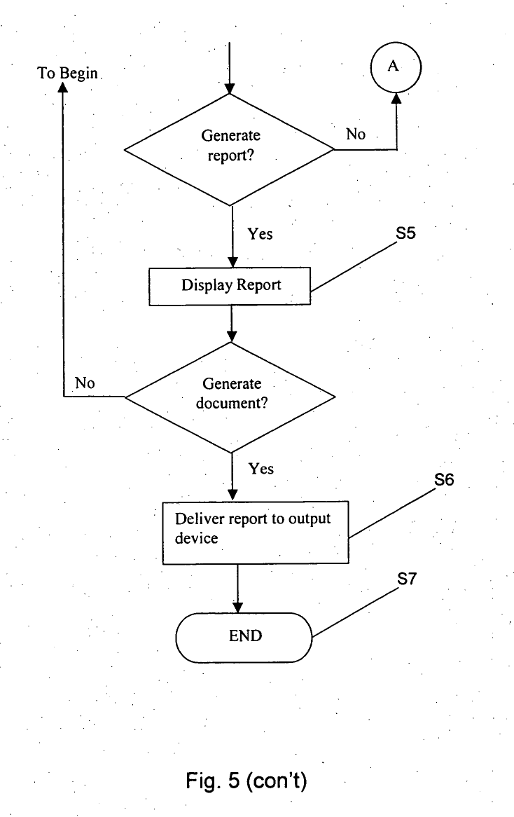

FIG. 5 is a flow chart depicting certain methods for generating reports in accordance with embodiments of the present invention. The method begins at step S1. At step S2 a selection of one or more products is received from a user via an input interface. Once the selection is received, the database is searched for product data for the selected products. If no product data exists in the database, then new product selections are required and the process returns to step S2. If, on the other hand, the database does contain product data for the selected products, the method proceeds to step S3, wherein the product data of the one or more selected products is retrieved from the database. Next, at step S4, the retrieved selected product data is illustrated in an output interface. At this point, the user may modify at least some of the product data illustrated in the output interface to generate additional product data. If such modifications are made, then the process returns to step S4, wherein the additional product data is illustrated in the output interface. If no modifications to the product data are made by the user in the output interface, the user may generate a report illustrating the contents of the output interface. If the user chooses to generate such a report, then the method proceeds to step S5, wherein the report is displayed. The user may then choose to generate a document illustrating the report. If the user chooses to generate such a document, then the method proceeds to step S6 where the report is delivered to an output device. The method ends at step S7.

It should also be apparent from the foregoing description that the present invention is also directed to methods of using a computer to compare products. As is apparent from the description herein, these methods of the present invention comprise the steps of (a) using a computer-based input interface to input a selection of at least two products to be compared, and (b) reviewing an output interface illustrating selected product data of the at least two products. In these methods of the present invention, the selected product data is retrieved from at least one database comprising product data of at least two products. At least some of the selected product data may be adjusted in the output interface prior to generating the report.

It will be readily appreciated by those skilled in the art that modifications may be made to the inventions without departing from the concepts disclosed in the foregoing description. Such modifications are to be considered as included within the following claims unless the claims, by their language, expressly state otherwise. Accordingly, the embodiments described in detail herein are illustrative only and are not limiting to the scope of the invention, which is to be given the full breadth of the appended claims and any and all equivalents thereof.

1. A computer based system for illustrating product data comprising:
(a) an input interface wherein a user selects one or more products;
(b) at least one database comprising product data of the products;
(c) a program in communication with the input interface and the at least one database, wherein the program retrieves selected product data for products selected by the user; and
(d) an output interface in communication with the program, which illustrates at least some of the selected product data,
wherein the computer based system is interactive with the user, such that the user may adjust at least some of the product data illustrated in the output interface to generate additional product data.

2. The system of claim 1, wherein the program communicates with the input interface, the database, and the output interface via a communication media comprising one or more types of computer networks.

3. The system of claim 1 further comprising a maintenance interface in communication with the database.

4. The system of claim 1 further comprising an output device in communication with the output interface.

5. The system of claim 4, wherein the output device is selected from the group consisting of a printer, a fax machine, a diskette and a compact disc.

6. The system of claim 1, wherein the user selects at least two products.

7. The system of claim 1, wherein the input interface comprises a plurality of input screens.

8. The system of claim 6, wherein the products comprise coatings.

9. The system of claim 8, wherein the product data illustrated in the output interface comprises one or more of component data, component-mixing ratios, and the RTS price of the coatings.

10. The system of claim 9, wherein the component data comprises at least one of a code, a description, a price, and a package size.

11. The system of claim 10, wherein the description designates a quality grade of the coating.

12. The system of claim 1, wherein the input interface comprises a product search tool.

13. The system of claim 12, wherein the search tool comprises a list of product suppliers and brands.

14. The system of claim 13, wherein the search tool comprises a list of paint lines.

15. The system of claim 14, wherein the search tool comprises a list of product mix categories.

16. The system of claim 15, wherein the search tool comprises a list of products.

17. The system of claim 1, wherein the program resides on a server.

18. The system of claim 1, wherein the database comprises product data for a plurality of products of a plurality of product suppliers.

19. The system of claim 10, wherein the user may adjust one or more of the component package sizes, component-mixing ratios and RTS prices illustrated in the output interface.

20. The system of claim 1, wherein system is capable of generating a report that illustrates the contents of the output interface.

21. A computer generated report illustrating the contents of an output interface, wherein the report comprises selected product data of one or more products, wherein the product data is retrieved from at least one database comprising product data of one or more products, and wherein at least some of the product data is adjustable in the output interface to generate additional product data.

22. A document comprising the report of claim 21.

23. The report of claim 21, wherein the report comprises selected product data of at least two products.

24. The report of claim 23, wherein the products comprise coatings.

25. The report of claim 24, wherein the product data comprises component data and one or more component-mixing ratios.

26. The report of claim 25, wherein the product data comprises at least one of a code, a description, a price, and a package size.

27. The report of claim 26, wherein the description designates a quality grade of the coating.

28. The report of claim 25, wherein the product data that is adjustable in the output interface comprises one or more of the component package sizes, component-mixing ratios and RTS prices.

29. A computer-based method for generating a report comprising product data of one or more products, the method comprising the steps of:
(a) receiving a selection of one or more products from a user via an input interface;
(b) retrieving product data of the one or more products from at least one database comprising product data of one or more products;
(c) illustrating selected product data of the one or more products in an output interface; wherein at least some of the illustrated product data is adjustable by the user in the output interface to generate additional product data; and
(d) generating a report that illustrates the contents of the output interface.

30. The method of claim 29, wherein step (a) comprises receiving a selection of at least two products from a user.

31. The method of claim 29, wherein the products comprise coatings.

32. The method of claim 31, wherein step (c) comprises illustrating selected product data comprising one or more of component data, component-mixing ratios, and the RTS price of the coatings.

33. The method of claim 32, wherein the component data comprises at least one of a code, a description, a price, and a package size.

34. The method of claim 33, wherein the description designates a quality grade of the coating.

35. The method of claim 29, wherein the input interface comprises a plurality of input screens.

36. The method of claim 33, wherein the adjustable product data comprises one or more of the component package sizes, component-mixing ratios and RTS prices illustrated in the output interface.

37. The method of claim 29, further comprising:
(e) delivering the contents of the report to an output device to produce a document illustrating the report.

38. A method of using a computer to compare product data, the method comprising the steps of:
(a) using a computer-based input interface to input a selection of at least two products to be compared; and
(b) reviewing an output interface illustrating selected product data of the at least two products, wherein the selected product data is retrieved from at least one database comprising product data of at least two products,
wherein at least some of the illustrated product data is adjustable by the user in the output interface.

39. The method of claim 38, further comprising:
(d) generating a report that illustrates the contents of the output interface.

40. The method of claim 38, wherein the selected product data comprises one or more of component data, component-mixing ratios, and the RTS price of the coatings.

41. The method of claim 40, wherein the component data comprises at least one of a code, a description, a price, and a package size.

42. The method of claim 41, wherein the description designates a quality grade of the coating.

43. The method of claim 38, wherein the input interface comprises a plurality of input screens.

44. The method of claim 37, wherein step (c) comprises modifying one or more of the component package sizes, component-mixing ratios and RTS prices illustrated in the output interface.

45. The method of claim 38, further comprising:
(e) delivering the contents of the report to an output device to produce a document illustrating the report.
